(19) United States
(12) Patent Application Publication
(10) Pub. No.: US 2003/0057708 A1
(43) Pub. Date: Mar. 27, 2003

(54) Wind power generator for vehicles

(75) Inventor: Chih-Peng Wu, Taipei (TW)

Correspondence Address: DOUGHERTY & TROXELL, SUITE 1404, 5205 LEESBURG PIKE, FALLS CHURCH, VA, 22041, US

(73) Assignee: Primax Electronics Ltd.

(21) Appl. No.: 10/079,530

(22) Filed: Feb. 22, 2002

(30) Foreign Application Priority Data
Sep. 24, 2001 (TW) 90123503

(51) Int. Cl. F03D 9/00

(52) U.S. Cl. 290/55

(57) ABSTRACT

A wind power generator for vehicles which have a pneumatic power source comprises an air vane set, a generator device and a rectifier. The air vane set receives the kinetic force of the pneumatic power source to drive a rotor of the generator device rotating. The rotor cuts through magnetic force lines in the generator device to generate inductive current. The inductive current is stabilized in voltage and rectified by the rectifier to supply output electricity for car use electric devices.

### FIELD OF THE INVENTION

The present invention relates to a wind power generator for vehicles and particularly a car generator that converts pneumatic mechanical energy to electric energy to power car use electric devices.

### BACKGROUND OF THE INVENTION

In the highly developed societies which have flourishing commercial and industrial activities and convenient transportation infrastructure, vehicles have become important transportation means in people's work and life. Moreover, increasing leisure time allows car owners to enjoy travels and outdoor recreational activities more conveniently. As a result, many people have spent a great amount of time inside the cars. To make driving car more enjoyable and comfortable, a wide variety of car use electric devices have been developed and introduced. For instance, car stereo, GPS (Global Positioning System), handsets, vacuum cleaners, notebook computers, air compressors, and the like are widely adapted for use in cars these days. To power more and more of these car use electric devices, demands for electric power and socket number also have increased.

FIG. 1 shows a conventional electric power supply system for vehicles. There are mainly two electric power supply sources for vehicles. One is the electricity supplied by the car storage battery 10, and another is supplied by the generator 11 driven by the engine. The storage battery 10 and generator 11 are electrically connected together, and linked through an electric line 13 to a cigarette lighter 12. When the vehicle engine is not running, the storage battery 10 is the main electric source. When the vehicle engine is operative, the generator 11 is the main electric source.

Whereas, the car storage battery 10 has limited electric power capacity, and must maintain sufficient power to start the engine. Hence, electric consumption from the storage battery 10 must be controlled and minimized whenever possible. Although the generator 11 can charge the storage battery 10 when the engine is running, many mechanical systems in the cars have gradually been replaced by electronic systems, such as electric power windows, electric adjusting rear view mirrors, and many other car use devices mentioned before, electric consumption in the car become very huge and often cannot be fully supplied by the generator 11. As a result, those electric demands heavily tax the storage battery 10. Moreover, conventional car cigarette lighter 10 functions as an electric power supply socket and has an unique shape which can provide only one type of voltage. It cannot fully meet electric requirements of different types of car use electric devices, and also is not compatible with general electric devices. In addition, the socket number in most cars nowadays cannot meet the requirements of increasing number of car use electric devices.

The previous discussions indicate that conventional vehicle electric supply system cannot fully meet the wide range electric requirements of many car use electric devices now on the market, and also becomes a heavy burden to the car storage battery. Hence how to provide additional electric power supply by adopting existing vehicle designs without altering the vehicle body construction and without adding loading of car storage battery, and to fully meet the electric requirements of various types of car use electric devices has become a critical goal facing the car manufacturing industry.

### SUMMARY OF THE INVENTION

The primary object of the invention is to provide a wind power generator for vehicles that converts existing pneumatic power source in the cars to electric energy to generate additional electric power to support the car use electric devices.

The invention mainly includes an air vane set, a generator device, a rectifier, a modulating device and an electric storage device. The air vane set is located in the outlet of the car pneumatic power source and is driven to rotate by the pneumatic power of output air. The air vane set has a spindle coupled with the rotor of the generator device. When the pneumatic power source drives the air vane set rotating, the rotor will also be rotated synchronously and cut through the magnetic force lines of the generator stator in the generator device to generate inductive effect and inductive current output. The output current then is rectified and stabilized by the rectifier, and modulated by the modulating device, and is fed to the electric storage device to become stable electric power. The electric storage device has sockets to couple and support various car use electric devices. When the car use electric devices are not in use, the invention may store the generated electric power for emergency or future use.

The air vane set of the invention includes a plurality of identical blades configured in symmetrical fashion. Each blade has identical air intake and discharge angles, installation angle and surface curvature. These angles and curvature allow air flowing over the blade surfaces to drive the air vane set rotating about the spindle. The blade profile may be adopted NACA blade cross section profile to reduce wind resistance and increase rotation speed to increase power generation. The air vane set may be an axial flow or cross flow type to match different space requirements. A protective frame may be mounted to the periphery of the air vane set to prevent surrounding objects from damaging the rotating blades and protect people from injury by incidentally touching the rotating blades. The protective frame has anchor apparatus for fastening the air vane set to the pneumatic source outlet through screws or coupling elements to receive air kinetic force.

Furthermore, the rectifier and modulating device may be housed in a control box which may have a modulating device and indication lights for adjusting electric output power to meet different requirements. The generator device and control box may be separated and linked by electric wires to match space constraints or operation conveniences. In the event that the generator and control box are separated, the control box may have a plurality of mounting elements for fastening to a suitable support object in the car by means of screws or coupling elements, or double-side adhesive tape.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional electric power supply system for vehicles.

FIG. 2 is a schematic view of a wind power generator of the invention.

FIG. 3 is a schematic view of an air vane set and a protective frame of the invention.

FIG. 4 is a sectional view of a blade of the air vane set.

FIG. 5 is a perspective view of a car use wind power generator of the invention.

FIG. 6 is an operation flow chart of a car use wind power generator of the invention.

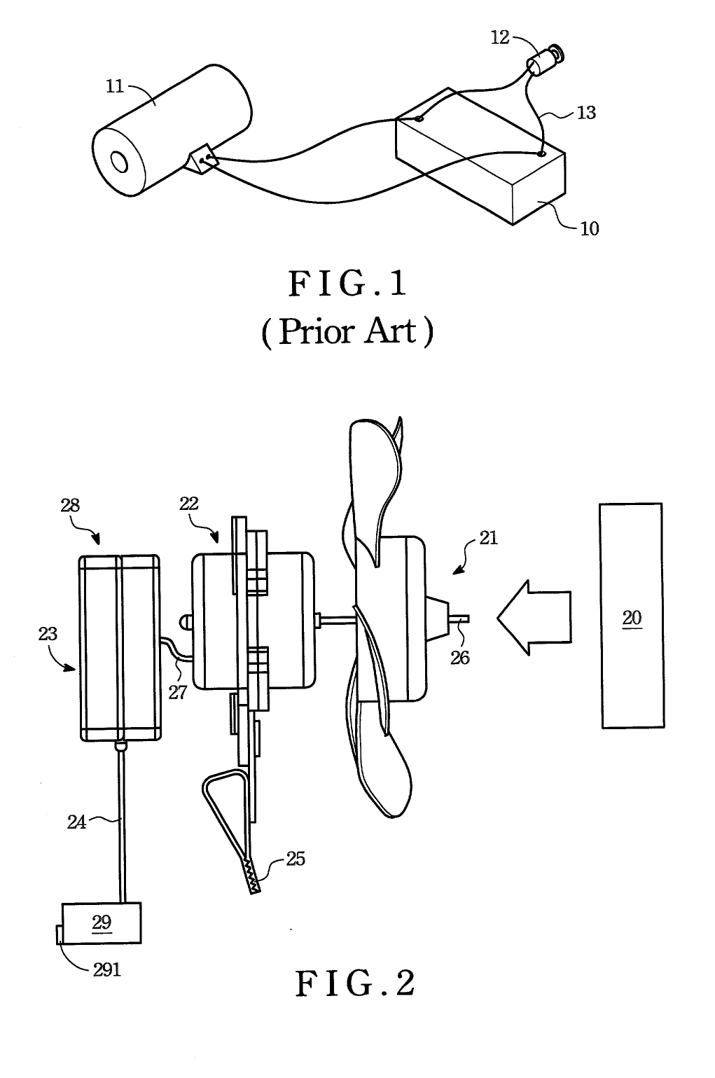

### DESCRIPTION OF THE PREFERRED EMBODIMENT

The invention discloses a wind power generator for vehicles that does not consume vehicle power or alter the vehicles, and utilizes an existing vehicle pneumatic power source to drive a generator device for generating electric power to supply car use electric devices, and through a rectifier and a modulating device to modulate current output to meet different electric requirements.

Referring to FIG. 2 for an embodiment of the invention, the wind power generator mainly includes an air vane set 21 mounted to an outlet 20 of a pneumatic power source (the pneumatic power source may be the air flow generated by the moving vehicles, or the air flow in the outlet of an air conditioner or radiator air fan). Air flow and air pressure passing through the outlet 20 drives the air vane set 21 and a spindle 26 where the air vane set 21 is mounted rotating. The spindle 26 also is coupled with a rotor of a generator device 22. Hence the rotor of the generator device 22 will rotate synchronously with the spindle 26. According to Faraday's law, changing magnetic field can generate electric induction effect. When the coil of the rotor crosses and cut through the magnetic field of the stator cyclically, an inductive current will be generated. The inductive current flows through an electric wire 27 to a rectifier 23 which stabilizes and rectifies the inductive current. The rectified current then flows to a modulating device 28 which modulates the current to required voltage and current for car use electric devices and also is delivered through another electric wire 24 to an electricity storage device 29. The electricity storage device 29 has a socket 291 to deliver electric power to a car use electric device or store the electric power for future use. The generator device 22 may be fastened to a support object by means of a spring clip 25.

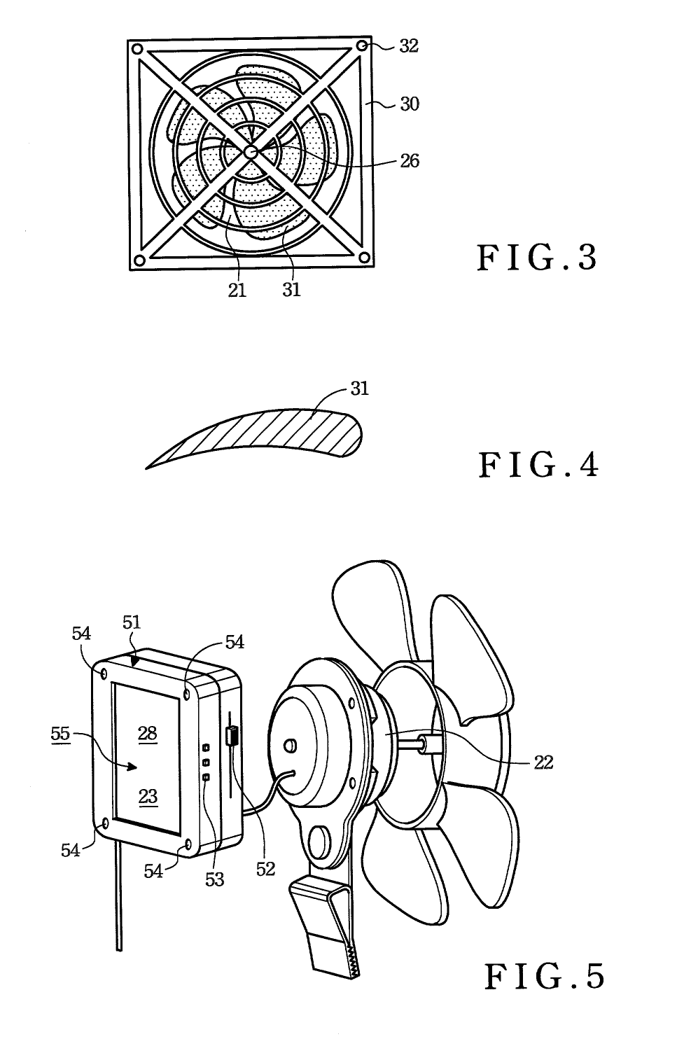

Referring to FIG. 3 for the assembly of the air vane set and protective frame of the invention. The air vane set 21 consists of a plurality of identical blades 31 fixedly mounting to and surrounding the spindle 26 in an equally spaced manner. Each blade 31 has an identical air intake angle and discharge angle, installation angle and surface curvature. Air flow passing over the surface of the blade 31 will change direction because of these angles and curvature. As a result, the blade 31 will generate a reaction force and rotate about the spindle 26. A frame 30 may be mounted to the periphery of the air vane set 21 to prevent surrounding objects from damaging the rotating air vane set 21 and protect people from injury from incidentally touching the rotating air vane set 21. The frame 30 may be formed in a cage structure to allow air to flow through freely to rotate the air vane set 21. Furthermore, the frame 30 may have anchor apparatus 32 for fastening the frame 30 to the air passage through screws or coupling elements to receive pneumatic power. In addition, the air vane set 21 may be an axial flow fan or a cross flow fan depending on different air intake forms of the vehicles to meet different space requirements.

Referring to FIG. 4, the blade 31 of the air vane set may be adopted NACA blade cross section profile to reduce wind resistance and increase rotation speed. This can also result in increased electric power generation and reduced noise to keep the interior of the vehicle quiet.

FIG. 5 illustrates an embodiment of the invention in use, the generator device 22 is an AC or DC power generator. The rectifier 23 and modulating device 28 may be encased in a control box 51. On the control box 51, there are a modulating device 52 and indicating lights 53 for adjusting output power to suit different electric power requirements. Moreover, the generator device 22 and control box 23 may be separated. In the event of separated installation, the control box 23 has a plurality of mounting elements 54 to facilitate installation through screws or coupling elements on a selected location where users can operate and control easily. The control box 23 may also be mounted by means of a double-side adhesive tape 55 (or Velcro strips) adhering to the back side thereof. The wind power generator of the invention may also be installed on the exterior of the vehicles for generating electricity. In such an occasion, the control box 23 and generator device 22 are preferably to have water-proof protection features to prevent water from seeping into the electric systems and causing damages.

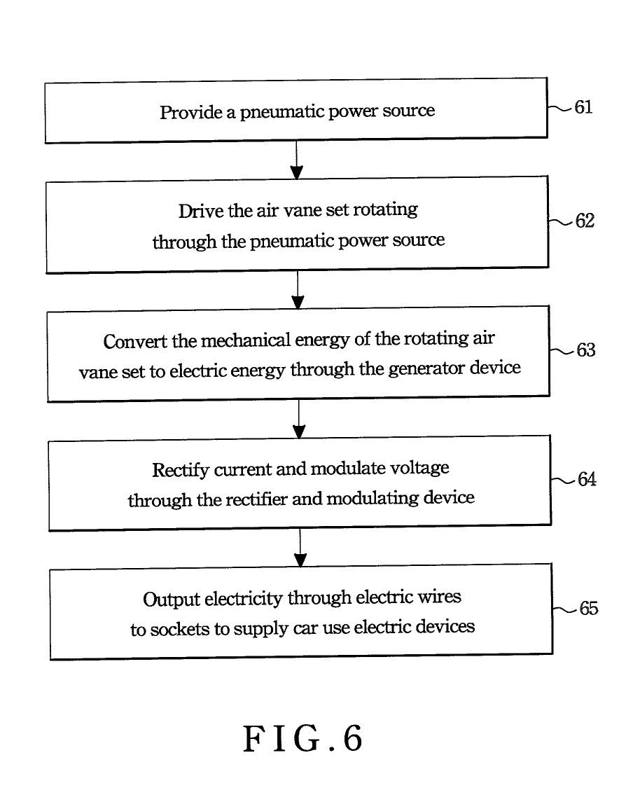

Referring to FIG. 6 for the operation flow of the invention which includes the following steps: providing a pneumatic power source (61); driving the air vane set to rotate through the pneumatic power source (62); converting the mechanical energy of the rotating air vane set to electric energy through the generator device (63); rectifying current and modulating voltage through the rectifier and modulating device (64); and outputting electricity through electric wires to sockets to supply car use electric devices (65).

When the invention is installed on the air inlet or outlet of the air conditioning system or engine radiator air fan, wind resistance will increase. However, good quality mechanisms in modern time usually have reserved sufficient safety factor in the design and manufacturing, hence wind power generated in the air conditioning system or radiator generally exceeding actual requirements. Therefore, there is extra wind power available for wind power generation use. In addition, when the vehicle is not fully loaded, the air conditioning or radiator also has less workload, and can spare extra wind power for generating electricity through the invention. Thus, the invention fits well to the contemporary concept of energy conservation and recycling.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A wind power generator for vehicles which have a pneumatic power source, comprising:
an air vane set having blades to receive the kinetic force of the pneumatic power source to generate rotation thereof;
a generator device coupling with the air vane set to rotate for generating inductive current; and
a rectifier electrically connecting the generator device for stabilizing the voltage of the inductive current and rectifying the inductive current for output.

2. The wind power generator for vehicles of claim 1, wherein the pneumatic power source is an outlet of an air conditioner.

3. The wind power generator for vehicles of claim 1, wherein the pneumatic power source is an outlet of a radiator.

4. The wind power generator for vehicles of claim 1, wherein the pneumatic power source is air flow generated when the vehicles are moving.

5. The wind power generator for vehicles of claim 1, wherein the generator device includes a stator and a rotor, the rotor rotating and cutting through magnetic force lines of the stator to generate inductive current through magnetic induction.

6. The wind power generator for vehicles of claim 5, wherein the air vane set has a spindle coupled with the stator of the generator device and driven the stator rotating to generate inductive current in the generator device.

7. The wind power generator for vehicles of claim 1, wherein the generator device is an AC and DC generator device.

8. The wind power generator for vehicles of claim 7, wherein the generator device is mounted to a support object by means of a spring clip.

9. The wind power generator for vehicles of claim 1, wherein the air vane set includes a plurality of symmetrical blades, each blade having a selected installation angle and a surface curvature to allow air flow to pass over and generate blade rotation about the center of the air vane set.

10. The wind power generator for vehicles of claim 1, wherein the air vane set has NACA blade cross section profiles to increase rotation speed of the air vane set and reduce noise.

11. The wind power generator for vehicles of claim 1, wherein the air vane set is selectively an axial flow type or a cross flow type.

12. The wind power generator for vehicles of claim 1, wherein the air vane set has a periphery surrounding by a protective frame to prevent people or external objects from touching the rotating blades.

13. The wind power generator for vehicles of claim 11, wherein the protective frame has a plurality of anchor apparatus for fastening the air vane set to receive the kinetic force of the pneumatic power source.

14. The wind power generator for vehicles of claim 1, wherein the rectifier and the generator device are separated and electrically connected through an electric wire.

15. The wind power generator for vehicles of claim 1, wherein the rectifier includes a control box which has a modulating device for adjusting output electricity to meet electric requirements of car use electric devices under selected conditions.

16. The wind power generator for vehicles of claim 15, wherein the control box has a plurality of mounting elements for fastening to users' end to facilitate users operation of the control box for control output electricity.

17. The wind power generator for vehicles of claim 16, wherein the mounting elements are selectively double-side adhesive tapes or Velcro strips adhering to a back side of the control box.

18. The wind power generator for vehicles of claim 1, wherein the rectifier further includes an electricity storage device for storing the rectified electric current.

19. The wind power generator for vehicles of claim 18, wherein the electricity storage device has a socket for providing output electricity to car use electric devices.
